(19) United States
(12) Patent Application Publication
(10) Pub. No.: US 2004/0086631 A1
(43) Pub. Date: May 6, 2004

(54) Ink jet printing device and method

(76) Inventors: Yu-Kai Han, Taipei (TW); Hsia-Tsai Hsiao, Miaoli (TW); Pi-Chun Weng, Taipei City (TW)

Correspondence Address: BIRCH STEWART KOLASCH & BIRCH, PO BOX 747, FALLS CHURCH, VA, 22040-0747, US

(21) Appl. No.: 10/689,672

(22) Filed: Oct. 22, 2003

(30) Foreign Application Priority Data
Oct. 25, 2002 (TW) 091125329

(51) Int. Cl. B05D 5/06; B05D 5/12; B05B 7/00; B05C 15/00

(52) U.S. Cl. 427/67; 118/300; 118/323

(57) ABSTRACT

An ink jet printing device for manufacturing an organic electroluminescent device. The ink jet printing device includes a chamber, an inkjet unit, and a pressure adjusting unit. The chamber has a space, and a basement is provided inside the space for supporting the organic electroluminescent device. The inkjet unit has a print head, which includes print holes. The print head is set in the chamber and is used to inject ink toward a substrate of the organic electroluminescent device. The pressure adjusting unit connects to the space so as to steady the pressure of the space within a specific value. Furthermore, an ink jet printing method for manufacturing an organic electroluminescent device is also disclosed.

### BACKGROUND OF THE INVENTION

1. Field of Invention

The invention relates to an ink jet printing device and an ink jet printing method, and in particular, to an ink jet printing device and method for manufacturing an organic electroluminescent device, which is an OLED or a PLED.

2. Related Art

An organic electroluminescent device is one of the most popular flat displays. The organic electroluminescent device employs organic functional materials, which can spontaneously emit light, to achieve the objective of displaying. It includes a pair of electrodes and an organic functional material layer sandwiched between the electrodes. When the electrodes are charged with a current or voltage, electrons and holes move and recombine in the organic functional material layer to generate excitons. The organic functional material layer can then radiate light of different colors according to their characteristics.

A vacuum evaporation process is used to form a film or layer of the organic electroluminescent device. The conventional vacuum evaporation process, however, includes a plurality of complex steps, which require a mask or masks. Therefore, it is a trend to use an ink jet printing method for manufacturing the organic electroluminescent device. The ink jet printing method can directly form an organic functional material layer on a transparent anode (one of the electrodes). In this case, the steps for forming the organic functional material layer are reduced, the mask or masks are unnecessary, and the manufacturing time and cost can be further decreased.

In the ink jet printing process, a print head injects ink to a transparent anode layer so as to form an organic functional material layer thereon. Due to gravity and the shape of the print head, the ink is injected from the print head with a tail. An undesired smaller ink drop may thus appear. This will affect the motion of the ink in a pixel, and decrease the uniformity of the manufactured organic functional material layer. In addition, the smaller ink drop caused by the tail of the original ink drop may drop into a nearby pixel. This will interfere another organic functional material layer formed in the nearby pixel, which emits a color differing from that of the currently processed pixel. Accordingly, the production yield and emitting efficiency are decreased.

It is therefore an objective of the invention to provide an ink jet printing device and method to improve the above-mentioned problems.

### SUMMARY OF THE INVENTION

In view of the above-mentioned problems, an objective of the invention is to provide an ink jet printing device and method, which can prevent the tail of the ink drop, and increase production yield and emitting efficiency.

To achieve the above-mentioned objectives, an ink jet printing device of the invention includes a chamber, an inkjet unit, and a pressure adjusting unit. The chamber has a space, and a basement for supporting an organic electroluminescent device is provided inside the space. The inkjet unit has a print head having a plurality of print holes. The print head is set in the chamber and is used to inject ink toward a substrate of the organic electroluminescent device. The pressure adjusting unit connects to the space so as to steady the pressure of the space within a specific value.

The invention further discloses an ink jet printing method for manufacturing an organic electroluminescent device. The method includes the following steps. First, a substrate of the organic electroluminescent device is provided in a chamber. The pressure of the chamber is adjusted with a pressure adjusting unit, so that the pressure of the chamber can be steadied within a specific value. An inkjet unit is employed then to inject ink toward the substrate.

Since the ink jet printing device and method of the invention can adjust the pressure of the chamber, the conventional tail of the ink drop does not appear. Comparing to the conventional technology, since the pressure of the chamber is adjustable, the surface tension of the ink drop may not affect by the reduced pressure of the chamber. Thus, the surface tension or cohesion of the ink drop becomes more uniform, which makes the ink drop present as a ball shape. The tail of the ink drop is therefore prevented, resulting in reducing the flow of the ink dropped onto the substrate. Accordingly, the uniformity of the manufactured organic functional material layer formed by the ink is improved. Furthermore, since the smaller ink drop may not appear and will not drop into the nearby pixel, the organic functional material layer formed in the nearby pixel is not interfered. Therefore, the production yield and emitting efficiency of the organic electroluminescent device are increased. In addition, since a vacuum pump is used to adjust the pressure of the chamber according to the properties of the ink solvent, the invention is superior in industrial applicability.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing an ink jet printing device according to a preferred embodiment of the invention; and

FIG. 2 is a flow chart showing an ink jet printing method according to a preferred embodiment of the invention.

### DETAILED DESCRIPTION OF THE INVENTION

The ink jet printing device and method according to preferred embodiments of the invention will be described herein below with reference to the accompanying drawings, wherein the same reference numbers refer to the same elements.

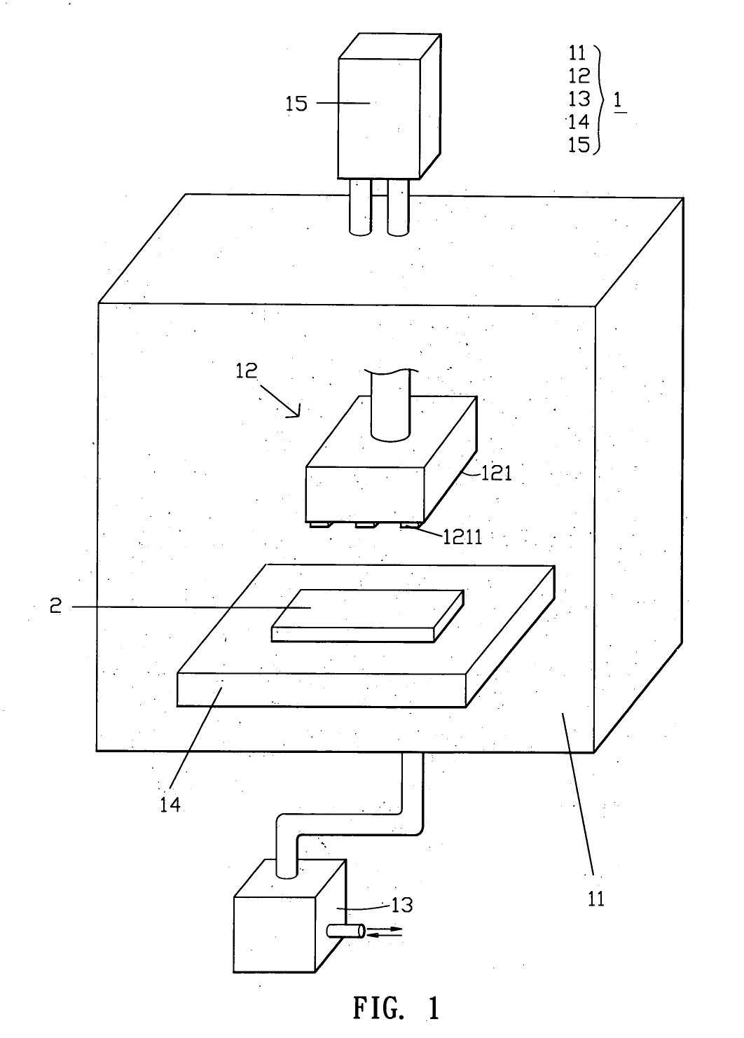

Referring to FIG. 1, an ink jet printing device 1 includes a chamber 11, an inkjet unit 12 and a pressure adjusting unit 13.

The inkjet unit 12 is set inside the chamber, and injects ink toward a substrate 2.

The pressure adjusting unit 13 connects to the chamber 11, and injects gas to or exhausts gas from the chamber 11. Thus, the chamber 11 can be steadied within a specific pressure, which is greater or less than 1 atmosphere. In the present embodiment, the specific pressure is 1±0.5 atmospheres. The pressure adjusting unit 13 of the invention includes a pump and a controller (not shown), which can achieve the objective of exhausting gas or injecting gas. The controller controls the direction of the pump, which is injecting gas to or exhausting gas from the chamber, and the amount of the injected gas or the exhausted gas.

With reference to FIG. 1, the ink jet printing device 1 further includes a basement 14 for supporting the substrate 2. The basement 14 and inkjet unit 12 are provided inside the chamber 11. It should be noted that the substrate 2 is an anode substrate such as an ITO (indium-tin) substrate or an AZO (aluminum-zinc) substrate.

The inkjet unit 12 is set opposite to the basement 14 (as shown in FIG. 1). Accordingly, the inkjet unit 12 injects ink toward the substrate 2 supported on the basement 14, so that an organic functional material layer is formed on the substrate 2. In this case, the inkjet unit 12 includes a print head 121 and a driver (not shown). The print head 121 includes a plurality of print holes 1211, and the driver is variable according to the requirement of the ink jet printing process.

During the ink jet printing process, the driver is a controller if the inkjet unit 12 is fixed and the substrate 2 is moved to control the position to be ink jet printed. The controller is used to control the flux speed and amount of injected ink. If the substrate 2 is fixed and the inkjet unit 12 is moved to control the position to be ink jet printed, the driver further includes a moving unit for controlling the position of ink jet printing. Of course, the substrate 2 and the inkjet unit 12 can be moved at the same time during the ink jet printing process.

The size and shape of the inkjet unit 12 are variable according to the dimension of the printed pattern and the property of the employed insulating material, i.e., the solution viscosity and particle size. The aligning method of the inkjet unit 12 is also determined according to the precision of the pattern of the insulating layer. For example, a mechanical alignment has a precision more than 50 micrometers, and an optical alignment has a precision more than 1 micrometer.

The ink jet printing device 1 of the embodiment further includes a freshening unit 15, which connects to the chamber 11. The freshening unit 15 can inject gas into the chamber 11, and exhaust gas from the chamber 11. Thus, the chamber 11 has a pressure higher than or lower than 1 atmosphere. In the present embodiment, the freshening unit 15 can exhaust air, water vapor, and organic solvent of the ink existing in the chamber 11. At the meanwhile, the freshening unit 15 further injects equivalent amount of gas into the chamber 11. Accordingly, the atmosphere in the chamber 11 is recycled, and is then refreshed. In this case, the injected gas is moisture-free and oxygen-free. For example, the injected gas is nitrogen or inert gas such as helium or argon.

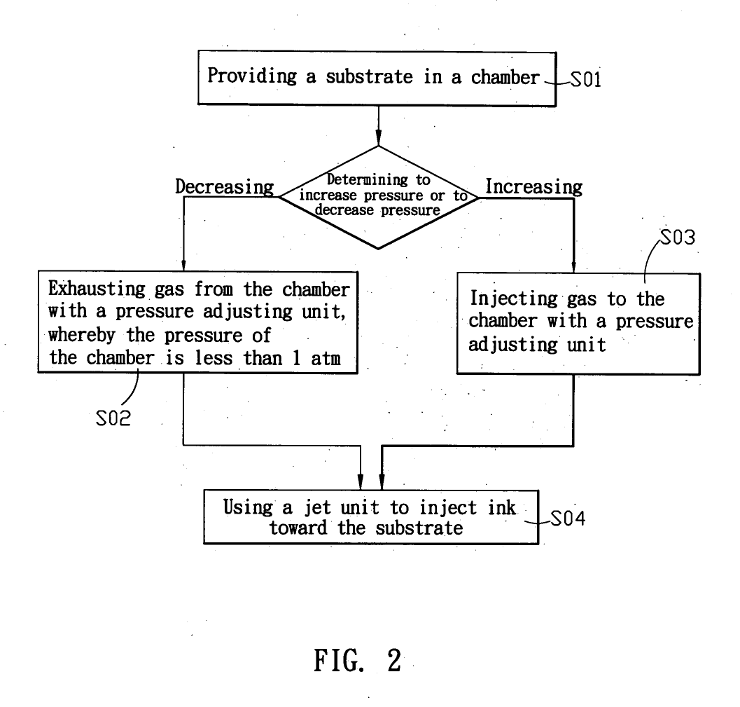

The ink jet printing method of the invention is described herein below with reference to FIG. 2, wherein all elements of this embodiment are the same as those mentioned in the previous embodiment of the ink jet printing device 1.

Referring to FIG. 2, the ink jet printing method for manufacturing an organic electroluminescent device of the invention includes the following steps of:

1. Providing a substrate in a chamber (S01);

2. Adjusting a pressure of the chamber with a pressure adjusting unit for steadying the pressure of the chamber higher or lower than 1 atmosphere, wherein if desiring to decrease the pressure, the pressure adjusting unit exhausts gas from the chamber (S02), and if desiring to increase the pressure, the pressure adjusting unit injects gas into the chamber (S03); and

3. Injecting ink toward the substrate with an inkjet unit (S04).

In step S02, a pump is employed to exhaust gas from the chamber so as to steady the pressure of the chamber, whereby the pressure of the chamber is decreased lower than 1 atmosphere. In the current embodiment, when the pressure of the chamber is lower than 1 atmosphere, the ink drop injected form the jet unit has uniform cohesion and surface tension. Therefore, the conventional tail of the ink drop can be prevented.

In the embodiment, the ink jet printing method further includes a step of utilizing a freshening unit to inject gas into and to exhaust gas from the chamber when the pump works (S02). In this case, the freshening unit can remove air, water vapor and solvent of the ink out of the chamber in step S02 or S03, and step S04. At the meanwhile, equivalent amount of pure gas is injected into the chamber. Thus, the pressure of the chamber is steadied at higher or lower than 1 atmosphere, and the atmosphere of the chamber is recycled.

The ink jet printing device and method can adjust the pressure of the chamber, so that the surface tension of the ink drop is changed. Thus, the conventional tail of the ink drop is prevented, which results in reducing the flow of the ink dropped onto the substrate. Accordingly, the uniformity of the manufactured organic functional material layer formed by the ink is improved. Furthermore; since the smaller ink drop may not appear and will not drop into the nearby pixel, the organic functional material layer formed in the nearby pixel is not interfered. Therefore, the production yield and emitting efficiency of the organic electroluminescent device are increased. In addition, since a vacuum pump is used to adjust the pressure of the chamber according to the properties of the ink solvent, the invention is superior in industrial applicability.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An ink jet printing device for manufacturing an organic electroluminescent device, comprising:
a chamber, which has a space, wherein a basement for supporting a substrate of the organic electroluminescent device is provided in the space;
an inkjet unit, which has a print head including a plurality of print holes, the print head being set inside the chamber and used to inject ink toward the substrate; and
a pressure adjusting unit, which connects to the space for steadying a pressure of the space within a specific value.

2. The device of claim 1, wherein the specific value is set between 0.5 atmospheres and 1.5 atmospheres.

3. The device of claim 1, further comprising:
a freshening unit, which connects to the chamber and injects gas into the chamber.

4. The device of claim 3, wherein the injected gas is inert gas.

5. The device of claim 4, wherein the injected gas is helium.

6. The device of claim 4, wherein the injected gas is argon.

7. The device of claim 1, wherein the pressure adjusting unit comprises a pump and a controller, the controller controlling the pump to inject gas to or to exhaust gas from the chamber, and the amount of the injected gas or the exhausted gas.

8. The device of claim 7, wherein the injected gas is moisture-free and oxygen-free.

9. The device of claim 7, wherein the injected gas is inert gas.

10. The device of claim 9, wherein the injected gas is helium.

11. The device of claim 9, wherein the injected gas is argon.

12. The device of claim 8, wherein the injected gas is nitrogen.

13. An ink jet printing method for manufacturing an organic electroluminescent device, which is performed with an ink jet printing device comprising a chamber, a pressure adjusting unit and an inkjet unit, the method comprising:
providing a substrate of the organic electroluminescent device in the chamber;
adjusting a pressure of the chamber with the pressure adjusting unit for steadying the pressure of the chamber within a specific value; and
injecting ink toward the substrate with the inkjet unit.

14. The method of claim 13, wherein the specific value is set between 0.5 atmospheres and 1.5 atmospheres.

15. The method of claim 13, wherein the pressure adjusting unit exhausts gas from the chamber to decrease the pressure of the chamber, and the pressure adjusting unit injects gas into the chamber to increase the pressure of the chamber.

16. The method of claim 15, wherein the injected gas is moisture-free and oxygen-free.

17. The method of claim 15, wherein the injected gas is inert gas.

18. The method of claim 17, wherein the inert gas is helium.

19. The method of claim 17, wherein the inert gas is argon.

20. The method of claim 16, wherein the injected gas is nitrogen.
